(19) United States
(12) Patent Application Publication
(10) Pub. No.: US 2004/0075574 A1
(43) Pub. Date: Apr. 22, 2004

(54) Sound communication

(76) Inventor: Patsy Carol McCallum, Pembroke, NC (US)

Correspondence Address: PATSY McCALLUM, P.O. Box 3996, Pembroke, NC, 28372, US

(21) Appl. No.: 10/199,135

(22) Filed: Oct. 22, 2002

(51) Int. Cl. G08B 25/08

(52) U.S. Cl. 340/692; 340/573.1; 340/384.1; 340/574

(57) ABSTRACT

The sound method or type is to alert of an immediate need to be addressed by the sound heard or received and sent. When an immediate need for attention occurs, to be alerted of what it and then take action. A sound is used to make you aware it being immediate. A sound to alert of the immediate need by way of selecting a button or number on the device, coded by problems and/or condition (immediate need). The specific immediate need of attention, are for heart conditions, heart attack, pregency, fallen, slip, hit head, and etc. The conditions would cover health needs, such as heart, false teeth, fainting, life or death situations and etc. The devices could be made with the sound used as regular, standard, general and high tech based on the type of need.

Once the sound is in place, the way to activate would be as simple as pressing a button.

A method by which a type of signal for attention needed to be given immediately by use of a communication device or item. The premieres communication service provider In a multi-service provider environment.

Mobile, channel, frequency, optimal, cellular, routine freq. band, cordless, freq channel, programming, voiced, telephone, sub code car radio . . .

This method is to alert one of an immediate need to be addressed by which a communication device uses a wireless, wired, standard to provide. The communication to be made in a Predetermined order or form. An alert of the specific need by a sound other than already programmed Into the communication service device.

To alert a specific need of immediate attention by a sound as already made in the communication service device.

The sound as a horn, siren, broken beeps, one unbroken tone, a pulsating sound and etc. The sound could be voiced, words, talking, music, loud noise, warring, These sounds must be stored single or multi in one type of communication device. The sounds many be added as one cense

The method is to alert of an immediate need to be addressed by programming the sound on the current Communication service device to make the sound by way of selecting a button or number on the communication device, coded by problems and/or one special button.

To alert a specific need of immediate attention by a sound such as a heart condition a specific type Of communication device made be made or an attentment to the present communication device.

The conditions would cover health needs, such as heart, false teeth, fainting, old, life or death and etc. This is as simply as a need to take a pill or drink if water.

The alert of a specific need should be added to the different classes of sound communication devices.

The method is to alert of an immediate need to be addressed by the sound communication devices to a Particular range of space, cover a specific area, usable in all geographic location, homes, office, Indoors and outdoors.

To alert a specific need of immediate attention by a sound communication device in hot, cold, wet and Dry conditions.

To alert a specific need of immediate attention by a sound communication device as regular, standard, General, high tech, life or death and etc.

To alert a specific need of immediate attention by a sound communication device for children use, senior Citizens, special jobs, special position of job locations, hearing impaired, blind, person with handicaps,

The method is to alert of an immediate need to be addressed by the sound communication devices to be Coded specific based on cost or location. Given a direct request of a person to upate by order and etc.

### BRIEF DESCRIPTION OF THE DRAWINGS

FIG. 1 shows a button added to the dial pad (front lower right corner/or side) would be pressed to give a sound. (hand held, desk, bedside, wall, and keyboards and etc. . . . )

FIGS. 2 and 3 show a button added other views for items with sound to alert immediate needs to also be pressed and/or colored (walkmans, CD player, computers, computer workstations, car radio, TV's and etc.)

FIG. 3 shows the button could be a special color or light up inorder not to mistake its purpose. Different colored buttons could give a sound, with words, based on the condition or need. (HELP!, PG!, HEART, HURT, FALSETEETH, FALLEN, DIANALYSES, UNSEEN or UNKNOWN HANDICAPS and etc.)

FIG. 4 shows the devices with the buttons to make the sound for immediate alert, to be add ons or as small attachments. (Wheelchairs, hand canes, chairs, office desk, and chair, pilots, to be added

FIG. 5 shows how FIGS. 1 and 2 should be covered by special waterproof, heat, cold and other materials for different places of use, on which the button is added. The use of battery, plug ins with on and off features in place. (bathroom, kitchen, poolside, outdoor activities, and etc.)

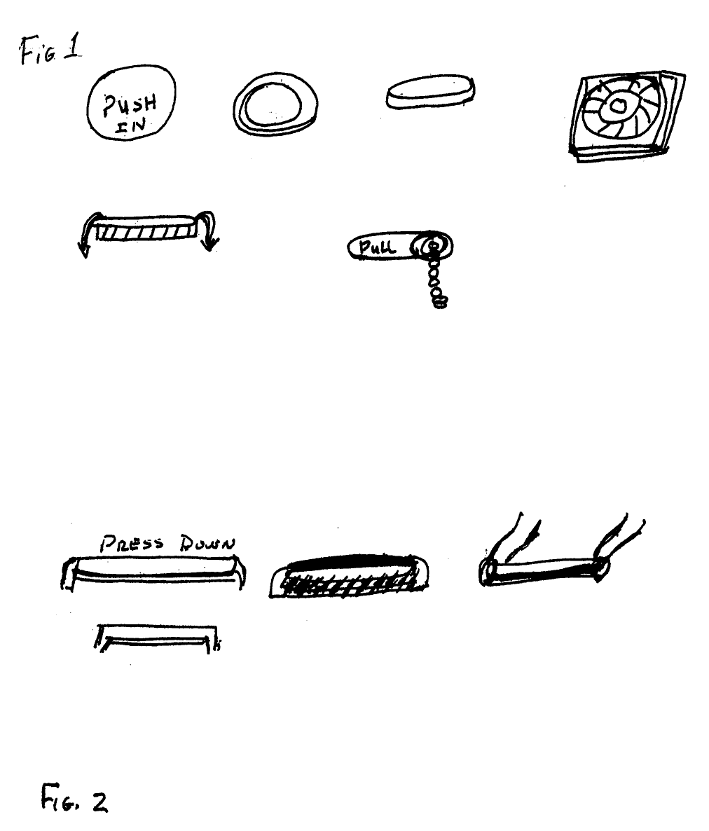

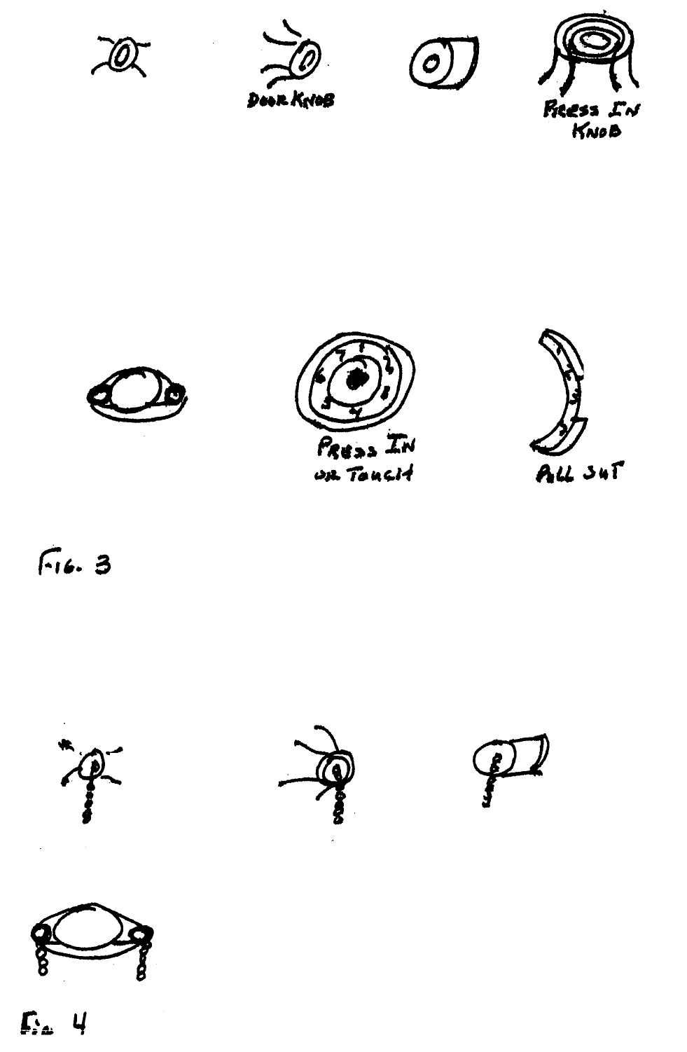

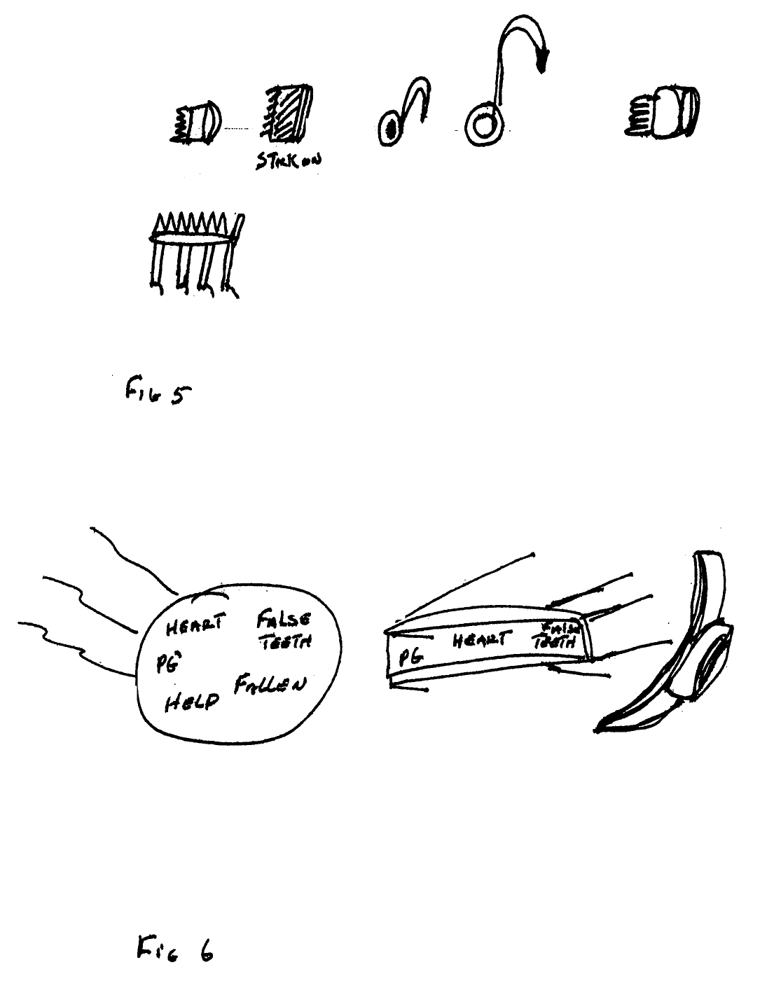

Other ways to release the sound may be developed as needed and/or necessary and etc.

The sound from the pressing of a button should get the immediate alert needed with little cost, very simple, easy and quick, act to preform. Even a child can press a button.

What is claimed:

1. A method by which a sound is used to alert of specific need of immediate attention. The sound would be in such a manner, loud, beeps, words, to get ones attention or the sound as a horn, siren, broken beeps, one unbroken tone, a pulsating sound and etc. The sound should be voiced, words, talking, music, loud noise, or a warning;
a sound already programmed by the specific need (name) is to be made as an alert. The sound as an alert to a need of attention, for heart conditions, heart attack, pregancy, fallen, slip, hit head, and etc. The specific need (conditions) would cover health needs, such as heart, false teeth, fainting, and make the difference between life and death and etc;
this sound can be added as an enhancement to items or devices with a sound feature or made to have a sound. The cost would be by general, regular, specific problem and/or high tech sound in or added to a device or made. The alert of a specific need should be added to the different classes of sound communication devices. A specific need of immediate attention by a sound communication device in hot, cold, wet and dry conditions, with a particular range of space, cover a specific area, usable in all geographic location, homes, office, indoors and outdoors;
a person, including children, would be able to activate this sound to alert for immediate need for attention with little effort. To alert a specific need of immediate attention by a sound communication for children use, senior citizens, special jobs, special position of job locations, hearing impaired, blind, person with handicaps, and etc.
to activate the sound is as simple as taking a pill with a glass of water. And updated as necessary.
